(19) United States
(12) Patent Application Publication
(10) Pub. No.: US 2007/0089687 A1
(43) Pub. Date: Apr. 26, 2007

(54) Screen leash

(76) Inventor: David Hamilton, San Diego, CA (US)

Correspondence Address: Karl M. Steins;Steins & Associates, Suite 120, 2333 Camino del Rio South, San Diego, CA, 92108, US

(21) Appl. No.: 11/258,978

(22) Filed: Oct. 26, 2005

(51) Int. Cl. B60R 22/00

(52) U.S. Cl. 119/771

(57) ABSTRACT

A Screen Leash is disclosed. The screen leash is made from an elongate strap that provides an extension to a screen door handle so that persons of short stature can more easily and safely open the door. The leash has an upper loop made from elastic material for attaching to the door handle and also to provide shock absorption when a user tugs on the leash. The leash also has a lower loop having an adjustable length so that the overall length of the leash can be set to conform to the particular door handle height of a particular recreational vehicle. A keeper may be provided to keep the lower loop in a more flattened condition to make the lower loop more manageable.

### BACKGROUND OF THE INVENTION

1. Field of the Invention

This invention relates generally to RV accessories and, more specifically, to a Screen Leash.

2. Description of Related Art

Recreational vehicles are wildly popular in the United States today. In virtually every one of these vehicles there is a side door entry that includes both a solid door and a screen door. If we turn to FIG. 1, we can examine the elements of a typical recreational vehicle.

FIG. 1 is a perspective view of a conventional RV 10. The RV 10 has a ground clearance 12 which is the distance between the bottom of the vehicle and the ground. In order to make the vehicle capable of driving over somewhat unpredictable roads, the ground clearance 12 typically will be in excess of 14 inches. Because a 14-inch step is excessive for adults, much less for children, most RVs 10 are provided with automatically retracting steps 22 that extend and retract automatically to assist the users to safely enter and exit the RV 10.

Since the floor of the RV 10 is still fairly high off the ground, the screen door 14 and the handle 16 used to latch and unlatch the screen door 14 tends to be fairly high off the ground as a result of the ground clearance 12. The handle height 20 tends to be 12 to 14 inches above a standard handle height for a normal door. It is this excessive height that creates the problems that are solved by the present invention. What is needed is a simple attachment for use to operate the handle 16 of a conventional RV screen door 14 so that the handle 16 can be remotely caused to operate along the path 18.

### SUMMARY OF THE INVENTION

In light of the aforementioned problems associated with the prior devices, it is an object of the present invention to provide a Screen Leash. The screen leash should provide an extension to a screen door handle so that persons of short stature can more easily and safely open the door. The leash should have an upper loop made from elastic material for attaching to the door handle and also to provide shock absorption when a user tugs on the leash. The leash should also have a lower loop having an adjustable length so that the overall length of the leash can be set to conform to the particular door handle height of a particular recreational vehicle. A keeper may be provided to keep the lower loop in a more flattened condition to make the lower loop more manageable.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional RV;

FIG. 2 is a perspective view of the RV of FIG. 1 with the screen door leash of the present invention installed;

FIG. 3 is a top view of the screen door leash of FIG. 2;

FIG. 4 is a partial perspective view of the leash of FIGS. 2 and 3; and

FIG. 5 is a partial perspective view of the leash of FIGS. 2 through 4.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Screen Leash.

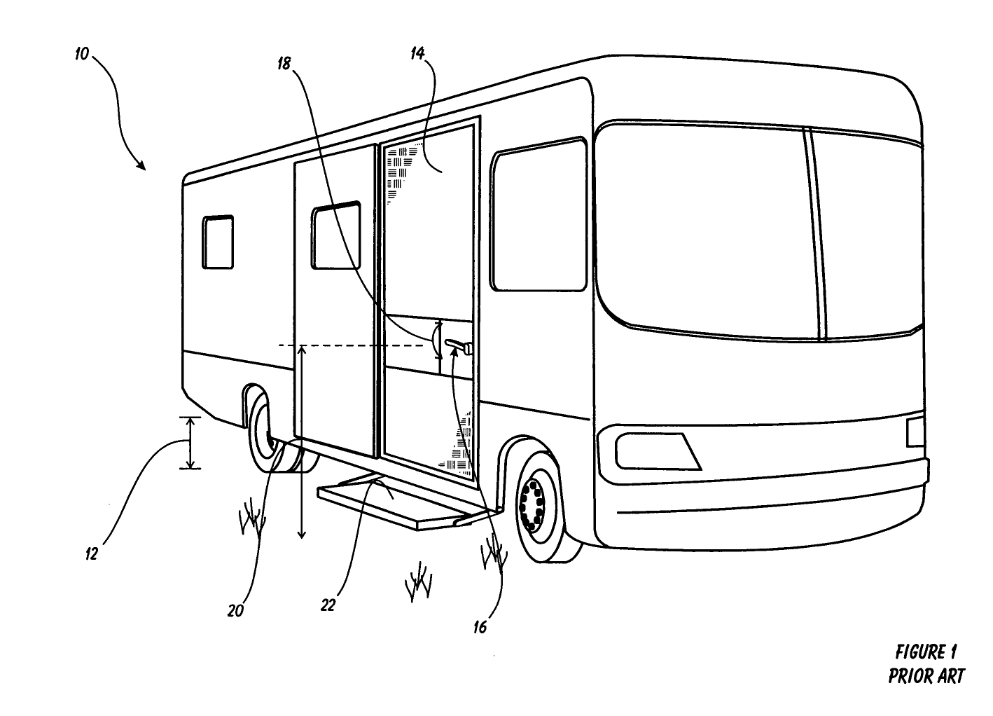

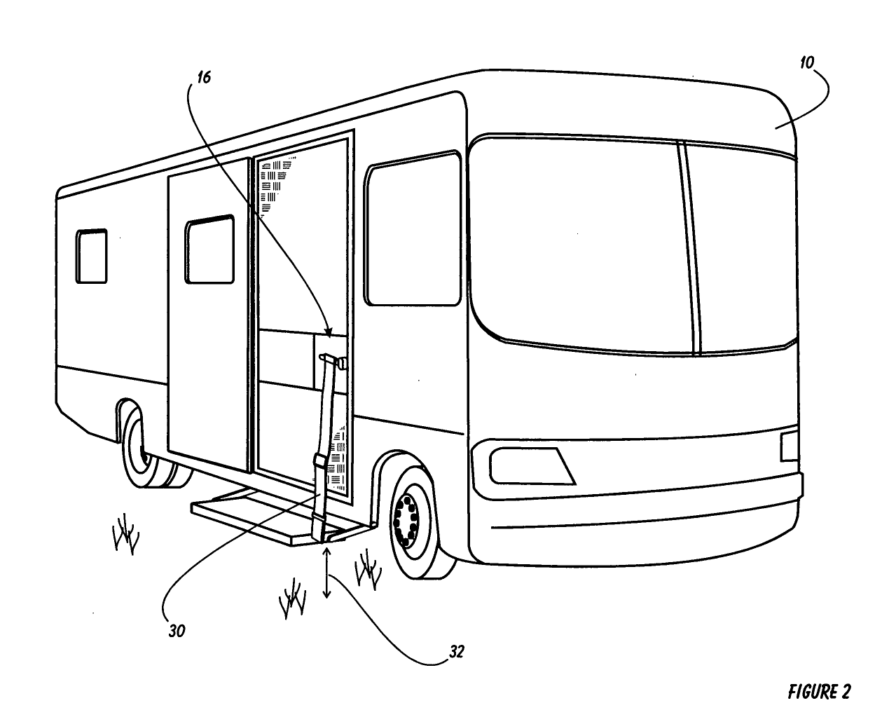

The present invention can best be understood by initial consideration of FIG. 2. FIG. 2 is a perspective view of the RV of FIG. 1 with the screen door leash of the present invention installed.

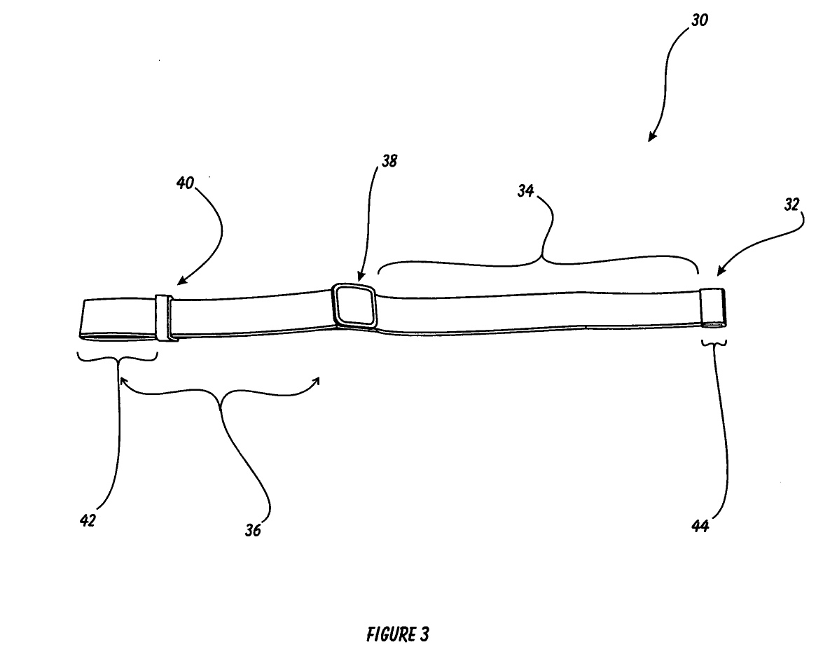

The preferred embodiment of the screen door leash 30 attaches to the handle 16 so that the user can easily grab the end of the leash 30 by one of its lower loops. As shown, the loop height 32 is adjustable so that it is convenient for adults and, more importantly, for small children. If we now turn to FIG. 3, we can examine the specific design of this unique device.

FIG. 3 is a top view of the screen door leash of FIG. 2. The screen door leash 30 comprises an upper section 32, an intermediate section 34 and a lower section 36. The upper section 32 is defined by an upper loop 40 made from an elasticized material that will accommodate a variety of sizes of screen door handles and will also provide a shock absorbing characteristic to prevent a child from damaging the screen door by pulling too hard or too sharply on the leash 30.

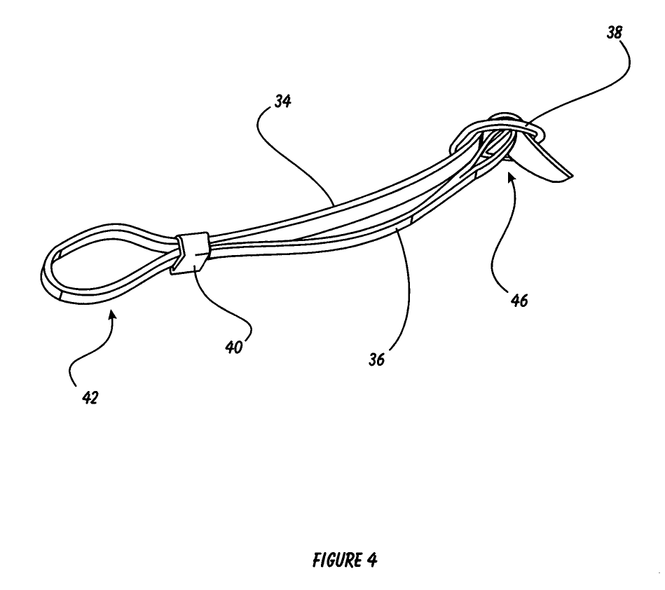

The intermediate section 34 transitions into the lower section 36 when the leash 30 passes the buckle 38. The buckle 38 can be adjusted to the right or to the left in this diagram in order to shorten or lengthen the overall length of the leash 30. A keeper 40 may be provided at the lower end of the lower section 36 so that a smaller lower loop 42 is created. If the keeper 40 is not used, then the lower loop 42 will extend from the buckle 38 all the way to the end of the leash 30. If we now turn to FIG. 4 we can examine another view of this invention.

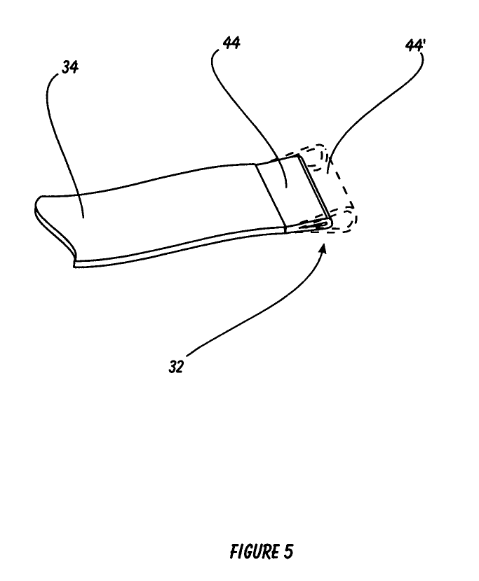

FIG. 4 is a partial perspective view of the leash of FIGS. 2 and 3. As shown in FIG. 4, the resilient nylon strap that comprises the intermediate and lower sections of the leash 30 passes through the buckle 38 creating a lower loop 42. The lower section 36 transitions into the end section 46 which is where the buckle 38 is sewn onto the leash 30. Again, as should be clearer here, if the buckle 38 is slid to the left as depicted here, the overall length of the leash 30 will be greater; however, if the buckle 38 is slid to the right as depicted here, the overall length of the leash 30 will be lessened. The purpose is to make the leash length user-adjustable specific to each user's needs. Finally, turning to FIG. 5 we can examine the aspect of this unique product.

FIG. 5 is a partial perspective view of the leash of FIG. 2 through 4. As shown in this diagram, the intermediate section 34 which is made of non-elastic—preferably nylon webbing-type material—has an upper loop 44 attached to it, such as by sewing and the like. The upper loop 44 defines the upper section 32. The dashed lines in this diagram depict the upper loop 44 prime as it would appear if it was being stretched such as when a child pulls on the leash 30. The elastic nature of the upper loop 44 and the choice of materials used in its manufacture is what provides this valuable expanding capability.

Those skilled in the art will not appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A screen leash, comprising:
a non-elastic elongate strap defining a first end and a second end; and
an upper loop formed from elastic material extending from said second end.

2. The leash of claim 1, wherein said leash comprises an upper section defined by said upper loop, an intermediate section extending from said upper section, and a lower section extending from said intermediate section and terminating in an end section at said first end.

3. The leash of claim 2, wherein said end section is attached to a buckle.

4. The leash of claim 3, wherein said intermediate section is threaded through said buckle.

5. The leash of claim 4, wherein a portion of said intermediate section and said lower and end sections form a loop, said loop threaded through a keeper.

6. The leash of claim 5, wherein said keeper comprises a closed loop-shaped element unattached to said strap.

7. A door handle extension device, comprising:
a non-elastic elongate strap defining a first end and a second end; and
an upper loop formed from elastic material extending from said second end.

8. The device of claim 7, wherein said device comprises an elongate generally non-elastic strap having an upper section defined by said upper loop, an intermediate section extending from said upper section, and a lower section extending from said intermediate section and terminating in an end section at said first end.

9. The device of claim 8, wherein said intermediate section is threaded through a buckle.

10. The device of claim 9, wherein said end section is attached to said buckle.

11. The device of claim 10, wherein a portion of said intermediate section and said lower and end sections form a lower loop, said lower loop threaded through a keeper.

12. The device of claim 11, wherein said keeper comprises a closed loop-shaped element slid over said intermediate section and said lower section forming said lower loop.

13. A strap comprising:
a non-elastic element defining a first end and a second end; and
an elastic element extending from said second end.

14. The strap of claim 13, wherein said non-elastic element comprises an elongate, flat, generally non-elastic strap having an upper section defined by said upper loop, an intermediate section extending from said upper section, and a lower section extending from said intermediate section and terminating in an end section at said first end.

15. The strap of claim 14, wherein said intermediate section is threaded through a buckle.

16. The strap of claim 15, wherein said end section is attached to said buckle.

17. The strap of claim 16, wherein a portion of said intermediate section and said lower and end sections form a lower loop, said lower loop threaded through a keeper.

18. The strap of claim 17, wherein said keeper comprises a closed loop-shaped element slid over said intermediate section and said lower section forming said lower loop.
